(19) United States
(12) Patent Application Publication
(10) Pub. No.: US 2008/0086738 A1
(43) Pub. Date: Apr. 10, 2008

(54) Mechanisms For Executing A Computer Program

(76) Inventor: Eero Nieminen, Tarvasjoki (FI)

Correspondence Address: SUGHRUE MION, PLLC, 2100 PENNSYLVANIA AVENUE, N.W., SUITE 800, WASHINGTON, DC, 20037, US

(21) Appl. No.: 11/632,294

(22) PCT Filed: Jul. 11, 2005
(86) PCT No.: PCT/FI05/50279

§ 371 Date: Jan. 12, 2007

(30) Foreign Application Priority Data
Jul. 12, 2004 (FI) 20045271

(51) Int. Cl. G06F 9/44

(52) U.S. Cl. 719/328

(57) ABSTRACT

An operating system is arranged to provide system services to an application requesting them, the services being selected from a predetermined system service group. The operating system includes main memory allocation logic, mass memory allocation logic, an application interface, via which the application program can request system services from the operating system, and application installation and execution logic for installing the application and for specifying its identifier. For preventing malicious programs, the inventive operating system comprises, instead of or in addition to a conventional user privilege administrator, an application privilege administrator responsive to a request for a system service transmitted by the application over the application interface. The application privilege administrator is arranged to administer the application privilege group such that it includes the right to use a subgroup of said system service group.

### BACKGROUND OF THE INVENTION

The invention relates to mechanisms, such as a method, an apparatus or a program product, for instance an operating system or an extension to an operating system, for executing a computer program. In the present context, the term ‘computer program’ refers to a program executed in a data processing system, which, in addition to a general-purpose computer, may be an embedded system, which are found for instance in mobile stations and electronic devices having updateable software.

One of the major problems in information technology is associated with programs that are harmful to data systems and networks, examples thereof including viruses, worms and Trojan horses. They intrude into the data system causing various damages to the data system itself and/or other data systems connected thereto. Within the scope of the present application, programs or program fragments causing or being able to cause damage are generally referred to as malicious programs.

The principal means for preventing malicious programs has been to identify malicious programs by means of protective mechanisms. Such preventive mechanisms include firewalls and virus scans, for example. Once a new malicious program, for instance a new virus, is identified, a representative sample (bit string) is taken thereof, and added to the database of the provider of the protective mechanisms, from where the users are able to update their preventive mechanisms. However, this technology is not watertight for several reasons, as persons skilled in the art are very well aware of. A specific problem is for instance that malicious programs are able to hide inside a seemingly good-natured program and are activated only after a long period of time.

### BRIEF DESCRIPTION OF THE INVENTION

The object of the invention is thus to provide a protective mechanism in a manner allowing the above problems to be solved. The object of the invention is achieved with a method, data processing system and software (operating system or an extension to it), which are characterized in what is stated in the independent claims. Preferred embodiments are described in the dependent claims.

The invention is based on the idea that the present program protection, which is based on the administration of privileges assigned to users, is insufficient. In the present context, a part of a computer or an operating system that administers users' privileges is called a first privilege administrator or user privilege administrator. In accordance with the invention, the computer or the operating system also includes a second administrator, i.e. an application privilege administrator, arranged to react to a situation in which an application transmits a request over the application programming interface (API) requesting a predetermined system service from the operating system.

From the point of view of security, it is preferable that the set of system services, to the requests concerning which the application privilege administrator reacts, is as wide as possible. By default, it is preferable to grant an application read access only to the file from which the application is initiated, and access to the user interface of the computer (the display, the keyboard and possibly an indicator device). When an application requests some system service to which it automatically has no access right by default, the computer or operating system according to the invention presents a dialogue to the user of the computer, requesting acceptance of the fact that a given application requests a given system service.

A normal user has the right to use the applications and files to which the system administrator has granted access rights. The use of the Internet may be allowed with restrictions or entirely prohibited. A system administrator is a user having the right to define the privileges associated with a given computer, a part thereof or a group of computers, privileges in a data network and/or a system. The system administrator also obtains a message about prohibited functions. There may be several system administrators having different privileges. Some changes specified may require a proposal or acceptance procedure, requiring that several different people make the change.

At the lowest level, the tasks of a system administrator include the addition and deletion of new users inside a group, and setting the privileges of directories and files belonging to the group (which may require acceptance from other administrators). With the highest privileges, a system administrator is able to install and update essential software associated with the system, which may include monitoring the system kernel and system connections. A non-technical assignor of file restrictions is a special system administrator capable of determining the publicity of the files and the transfer privileges inside the network and the publicity of the files to the outside.

Application-specific privileges to different files can be determined in the data system according of the invention. By default, a minimum set of privileges can be applied, the applications having no other access to the files than the read access of an application to the file from which it was started. Other privileges have to be separately added to the application.

The right of applications to use peripherals or a telecommunication connection (local area network, the Internet, etc.) can also be restricted or entirely prohibited. The restrictions may cover the entire peripheral or type of telecommunication connection (e.g. all use of the Internet) or only one specific manner (a certain protocol, gate and/or direction in the Internet). Privileges can also be determined for the functions allowed to said program when the other functions are prohibited. For example, a Telnet session by the Telnet program may be allowed while the others are prohibited. The destination may also be restricted, whereby a connection in an internal network is free but there is no access to an external network. However, in certain situations, the user may exceptionally grant (such as in connection with file processing) one-time access right to an application also as regards others than files.

If an application has a continuous connection option, then the file access rights should preferably be as restricted as possible in order to prevent background file transfer without the user's permission.

Installing new software into a computer can take place either from a transferable storage media or by loading the software over a network (from the provider's Internet pages or some other location distributing software).

The right to initiate new software for the first time and/or to perform certain functions can be given only to system administrators. However, software employing only a user interface and having restricted modification of files can also be installable by a normal user. Such programs may include conversion and analysis programs etc., for example, which read from other files (read-only) and write in other (new) files with the user's consent making the damage minimal, even though the program turned out to be a malicious program. Another example is a file-browsing program, which only reads the file and displays its information on a display, possibly including the option to print a hard-copy. However, if such a program were to try to use prohibited functions (e.g. the Internet), the execution of the prohibited function would be prevented and a message would be transmitted to the system administrator. In addition, in association with a prohibited function, the system may always store information about the state of the program for later analysis. The prohibition of certain functions prevents a malicious program (e.g. a spying program) from transmitting further any data it collected, from spreading within the network and from causing the system any other damage.

During the first start-up, all applications preferably only have access right to the user interface, which includes a display and an input device (a keyboard and possibly a mouse). Depending on the application, the first program to be started is either an installation program that creates an operating environment for the actual program and, at its simplest, only an application in the form of one file. An installation program typically decompresses the software components (files) and creates a home directory for the application. When the user starts the application for the first time, it has no other access right to the files and the directories than read access to the program file from which the application was started. If the application is started for instance from a CD, the installation program is typically given access to said CD.

When an installation program has to create a home directory for the application, the installation program transmits a system request to the operating system specifying the properties of the home directory requested by the installation program. The system checks if the user has the right to create the directory. If so, the system opens a query window for the user requesting acceptance to the creation of the home directory in a certain place in the directory system and its future privileges. The location of the home directory can also be determined different from the proposal. Next, the system creates the directory to which the installation program, or if the application directly creates the home directory, the application itself, has access right in a manner accepted by the user. Then the installation program/application initializes the home directory and creates the necessary files. Any other telecommunication manners required by the program can also be initialized at this stage. For example, allowing the program to use the Internet to some predetermined addresses or freely by using given protocols. Once the initialization is terminated, an operating environment is created for the application wherein it can operate, i.e. it has accurately specified privileges within the scope of the system, including the right to use previously specified files, for example.

Run-time files and protocols for modifying their privileges and names that are allowed when a task/file is opened in the application may also be specified for an application. The easiest way to determine such an operation is by the installation program, the installer of the application accepting the use of different types of files, e.g. temporary, background/backup files (name.tmp, name.bak, wherein ‘name’ is the name of the original file without an extension). The specifications can be changed later, and the system maintains information about the privileges in a database, where the user may study and change the privileges allowed.

As an example may be mentioned a text processing program that opens file ‘text.txt’ on the basis of the user's selection and acceptance. The system then concludes that the user also implicitly gave the text processing program the right to delete an earlier background copy ‘text.bak’, to rename file ‘text.txt’ ‘text.bak’ and to create a new temporary file ‘text.tmp’, whereto the original text file is copied. File ‘text.tmp’ is then edited. Once the file editing is finished, file ‘text.tmp’ is renamed ‘text.txt’. In this manner the normal operation of programs that use intermediate or background files is enabled without any need to separately request permission from the user to amend each file.

By default, besides the start-up file, an initialized application has no access right to other system files than those that were separately assigned to the application in connection with the installation. In normal operating situations, the use of the files specified in the installation is sufficient, and other privileges may impair system security. When the user starts an application and wishes to use the application for processing a file, the application usually has no access right to said file.

The user may temporarily grant the application a right to use a file, provided the user has a right to the file. Granting of the use right takes place by the application specifying, to the operating system, the properties that the files to be opened should have (at least read/write access, file type or types the user can select from). Once the properties of the file are specified, the application executes a system call including the specification of the file properties as parameter. The operating system creates a selection window onto the display, and the user is able to select one or more files from the window. Once the user has selected the file(s) and accepted the privileges the application will have to be able to use the file(s), the operating system opens the file(s) and returns the handle to the opened file(s). The application is now able to use the file(s) by the access rights and restrictions accepted by the user. Since a corresponding manner of selection is in use in present graphic operating systems, the system of the invention operates transparently as regards the user. From the point of view of the user, only the temporary transfer of access right, invisible to the user, is new to the application.

The selection window only shows the files from which the user is able to select on the conditions set by the application. For example, if write access is specified as a requirement, the files to which the user has only read access are not shown. The user may select different conditions as the basis of the selection, of which the application is also informed. Such a situation may arise when the user wishes to use a text processing program to look at a file to which the user only has read access. A text processing program operated in the usual manner tends to open all files with write access, too (initially only the files to which the user has write access are shown in the selection window). As a result of the deviating selection, the text processing program now operates in read-only mode and makes a remark if attempts are made to make amendments.

If the application is designed for present operating environments, wherein a selection window call is separately made for restoring the name of a file, and the following file opening call, compatibility can be achieved by the system enabling the opening of a file with the same name later with similar (or more constricted) conditions as were in the selection window accepted by the user. However, the selection window displayed is identical.

If the application is of the type wherein one or more files are opened and read, and a new file is created, wherein the writing takes place, this situation, too, can be allowed often without confirmation from the user. This is the case particularly when start-up takes place on a command line, where the files are also specified. However, if the application deletes or empties a previous file, this cannot be accepted without confirmation from the user, unless the application has access right to the file (for instance a situation wherein the same application created the file previously).

Normally, although a file is created under an application, the application is not given access right to the file; instead, the access right is given to the user. Read access to the result produced in the previous step can be given to a program that processes data in a chain (often started from the command line) and is in the following step. Instead or in addition, access right to some applications or an application group can be given to all files in the specifications of some directory. As an example may be mentioned a program development environment comprising an editor and a necessary compiler, which again is composed of several programs to be executed in succession.

If some file type is in the use of one set of software only, particularly in a situation wherein the file is opened for reading only, user acceptance is not usually required. On the other hand, in these situations, the intention is to look at the content of the file and only one application is able to show it, and therefore by selecting said file, the user implicitly gives the application read access to the file.

To increase compatibility with old software, which is not designed for a system protected in accordance with the invention, restricted access right to a directory can be given. This being so, the application sees the file names and may try to open the file without the user's acceptance. This manner is usable also in connection with programs started on the command line as regards others than files specified on the command line. When such an application tries to open a file, the user is presented a query requesting permission to use the file.

Most old applications are also well tested and received from secure sources, whereby old applications can also be given corresponding access rights as the users to certain directories and files (file types). In these situations, too, the damage caused by any malicious program is limited to the specified files only without compromising the safety of the rest of the system.

If a file is opened for read-only access (as a user selection or because the user has no write access), then a write request generated by the application causes an error condition. If the user only selected read access, the system may inquire about write access, provided the application has specified that write access is required in the situation. Such a situation may arise if the file has (for the sake of security) been opened at first for read-only using only read access, but the user wishes to edit the file and save the change. The application is unable to directly change the user's file access rights, but the change always takes place by means of a system call, and the system requests for permission to the change from the user. If the user has no right to the change, the request to change returns as an error situation to the application.

If the file is specified as generally readable, then reading thereof is possible without separate opening measures or keys. For these files, a mere opening request using a name and/or search path is sufficient. Typically, such files exist in servers containing public material and connected to the Internet. However, changing these files, too, is subject to the user having normal access right to change, whereby opening by using write access takes place in the same way as for any other file. Alternatively, consent to the writing may be requested in connection with the storing.

The owner of a file may also be an application in which case the users' read/write access is limited or entirely prohibited. As an example of such usage may be mentioned files comprised by the database of a database program, which are usable only by using the database program. An application may have the same access right to files, as do the users.

File-specific usage limitations may be employed to delimit the distribution of files and other functions. Examples of restrictions associated with usage:

a mark in a log file about the opening of a file
printing prohibited, only reading on the display allowed
transfer prohibited (usage only in the original location)
transfer prohibited to the outside of an organization
transfer outside the organization allowed only to predetermined destinations (e.g. to business partners over the Internet)
   public, free for distribution.

Usage restrictions may also be time-bound, for instance a newssheet may be secret at first, but free for distribution after the time of publication.

An application may have several projects registered to the system, which can be easily opened without each file being separately verified. One project may comprise a plurality of files. An example of a project is an integrated program development environment having dozens of source code files and in addition several library files. The project may have only read access to the library. In such a situation, the different applications may also have access right to the same file, whereby an application does not require separate permission from the user for processing the file. Access rights are specified in the system when files are added to the project. The rights of the applications are defined when the software is being installed; for example, an application may be defined as software operating according to the project principle.

In accordance with a preferred embodiment, the computer and operating system of the invention maintain historical data. When a user opens an application that he used previously and then closes it in such a manner that the files used by the application remain open, the application is able to store the current status in a history file indicating to the system that the opened files will open automatically when the same user starts the same application the next time.

This function is usable in situations wherein the application returns to the state wherein it was before being closed. For example, a text processing program may open a file and return to the same place where the cursor was when the user last finished working. This being so, the user is able to continue his interrupted work without separate opening of the files. Another example is the ability to reopen files that were last open from a menu. History data about files may be maintained for a longer period if useful in view of the usability of the application. Yet further, such history data may be used to improve usability such that the next time a user uses an application to access mass memory, the resulting dialog window begins in the directory last used by that application. It is preferable to offer this convenience feature as a system service because the application itself may not be allowed to see the directory structure of the mass memory. For example, the user may have stored an attachment file received via e-mail. Next, the user opens a second file into which the attachment file is to be inserted. Because the attachment file was saved in a different directory from the one which relates to the present work, it is a time-saving feature to be able to quickly access the directory in which the e-mail attachment was saved.

In addition to offering a few previously used directories for quick access, the system can offer a few directories used by the user and/or application for quick access. The list of directories for quick access is preferably user-modifiable.

### Passwords and Software Privileges

All confirmation queries and logins preferably take place via the system, and no information thereon is transferred to applications other than if the function requested is accepted or rejected. Except for system tools (i.e. an application whose privileges allow operation as a system tool), the applications are not able to make changes to system-level settings, even if they possessed user ids and passwords or the corresponding data allowing a registered user to make changes. This ensures that information obtained via a spying program or in another manner cannot be used to break into the system or change the privileges or settings of applications and/or users.

Some applications may have broader rights to make changes in the system than a user does, whereby the user's rights are a limit to allowed changes, i.e. the user is able to assign privileges to an application within the limits of his own privileges.

Examples of applications that may have broader rights to changes than users include system management tools for specifying the privileges of applications and users.

By default, an application has no right to use a network, or the right may be restricted only to certain addresses (e.g. business partners) and/or protocols. In this case, too, it is preferable to request confirmation from the user before setting up the connection.

However, a network administrator may allow broader rights to certain reliable programs to use the Internet. Examples of such programs are various programs used in telecommunication (www browsers, Telnet, FTP, etc.). In these cases, the protocols are limited and only communication outward is allowed, i.e. the system does not act as a server without the user's knowing, for example. However, file access right should not be granted to such programs without the user's selection, allowing a background transfer without the user's knowledge to be prevented. Usage restrictions may be specified for files, preventing them from being transmitted via the Internet. For example, if a usage restriction is associated with a file, preventing it from being transmitted to the Internet, such a file is not transmitted to the Internet.

If a server application is installed in a network, then its network privileges are determined in a manner allowing the server application to reply only to external queries, and all files to be used are only readable by using the server application. Other files may be invisible. To other applications, the files are usable as usual (depending on the user).

In the reception of email, a protocol should be used that includes a check of the transmitter's authenticity. This may take place for instance by inquiring of the server from which the message seems to have arrived (based on the transmitter's verbal address, not numerical IP address) if it transmitted the message. If not, then the transmitter's address is likely to be forged, and the message can be rejected. In addition, encryption, a digital signature and confirmations can still be used to increase the certainty of the authenticity of the message (legally demonstrable as valid).

In remote use, a user of a remote computer can exercise privileges of a local computer via a channel secured by encryption. File processing and other system commands have to be transmitted to the system by using encrypted key codes. These highly encrypted code keys ensure that malicious programs operating in the other computers of the network cannot change the specifications, files or file specifications of a protected computer.

In addition to file usage, similar restrictions associated with the usage are associated with network usage. The restrictions of the usage of the internal network of an organization are usually associated with file usage restrictions, but restrictions external to the organization may be associated with restrictions concerning file distribution.

### BRIEF DESCRIPTION OF THE FIGURES

In the following, the invention will be described in more detail in connection with preferred embodiments with reference to the accompanying drawings, in which

FIG. 1 shows the architecture of a data system according to the invention;

FIG. 2 shows the installation of an application program;

FIG. 3 shows a signalling process in connection with the execution of an application program;

FIG. 4 shows a user interface when an application program usage administrator requests that a user update the privileges of the application program; and

FIG. 5 shows a dialogue window when an application privilege administrator requests permission for executing a function from the user of a computer.

### DETAILED DESCRIPTION OF THE INVENTION

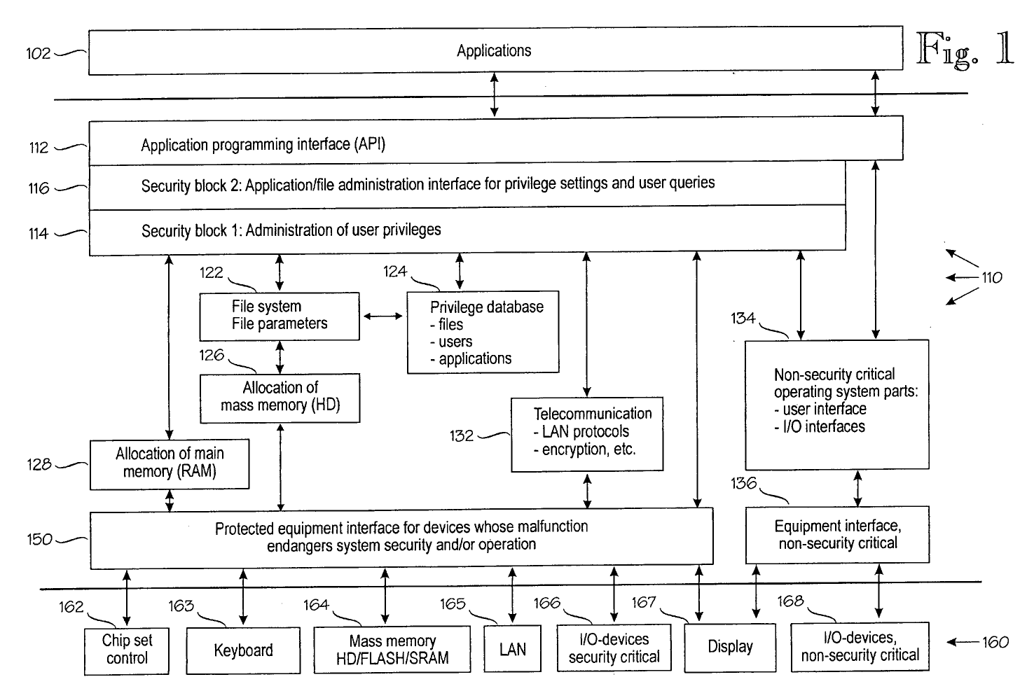

FIG. 1 shows the architecture of a data system according to the invention. A typical example of a data system is a general-purpose computer, but the data system of the invention may also be applied to other data processing systems, such as mobile stations and embedded systems. The data system comprises equipment 160 and an operating system 110. In this typical, but non-restrictive example, the equipment 160 comprises the following blocks: chipset (including main memory) control 162, keyboard 163, mass memory/memories 164, local area network 165, security-critical input/output devices 166, display 167 and non-security-critical input/output devices 168.

A user uses applications generally denoted by reference numeral 102. The applications 102 do not use the equipment 160 directly, but via an application programming interface (API) 112, as is evident to those skilled in the art. For example, an application does not have to know to which device port or address a disk drive is connected or which of its sectors contains free space. Instead, the application 102 transmits service requests, i.e. system calls, via the application programming interface 112 to the operating system 110. If a service request relates to a disk drive, the operating system 110 processes it, taking into consideration the file system and file parameters 122 of said disk drive, and transmits the request to a mass memory 154 via a protected equipment interface 150 of an allocation logic 126 of the mass memory. Correspondingly, telecommunication takes place via telecommunication logic 132 to telecommunication equipment, which in the example of FIG. 1 is represented by a local area network 165, via which for instance the Internet traffic is assumed to take place. All elements of FIG. 1 described so far may be of conventional technology.

Because of security aspects associated with users, a first, i.e. a user privilege administrator 114, which may also be of conventional technology, is generally comprised by or associated with the application programming interface 112. The user privileges administrator 114 uses a privilege database 124, in which is stored information about the rights each user or user group has to the different parts of the system. In several single-user systems, the user privileges administrator 114 may be disabled or totally lacking, whereby each user is automatically a super user.

As was explained in connection with the approach to the problem, management of user privileges does not constitute a sufficient protection against malicious programs, since a malicious program automatically inherits user privileges. The data system according to the invention, particularly the operating system 110, therefore contains a second privilege administrator 116 administering the privileges of each application 102. The application privilege administrator 116 is arranged to administer the privileges of each application 102 on the basis of the identifier of said application, i.e. not on the basis of the user's identifier. Its operation may be largely analogous to the operation of the first, i.e. the user privilege administrator 114. An essential difference is in that when the user privilege administrator 114 checks if said user has the right to the requested operation, then the application privilege administrator 116 checks if said application has the right to the requested operation.

Since the application privilege administrator 116 is part of the operating system 110, a malicious program cannot bypass it in order to request system services from the equipment 160. Only a very small number of system services may be requested from the equipment 160 via the application programming interface 112, other than via the application privilege administrator 116. As examples of such services may be mentioned the use of a restricted display 167 and the non-security-critical input/output devices 168.

When an application requests 102 a security-critical system service, i.e. a service implemented via the equipment interface 150, via the application programming interface 112, the application privilege administrator 116 applies a set of default-value privileges to the application. The set of default-value privileges may be fixedly coded in the application privilege administrator 116 or it may be maintained in the privilege database 124. The set of default-value privileges typically contains the right to limited use of the display 167 (but not the right to change display settings, for example). When the application 102 requests a system service not belonging to the default-value privileges, the application privilege administrator 116 inquires permission to this of the user of the computer. An exemplary dialogue window for this purpose is shown in FIG. 5. Inquiring permission of the user also takes place as a function of the operating system 110, not of the application 102.

Accordingly, it is essential that the application privilege administrator 116 according to the invention is part of the operating system 110, or an extension of the operating system located between the application programs and any of the security-critical functions of the operating system. As is evident to those skilled in the art, the operating system usually operates in a processor operating state, wherein different processes are isolated from each other, i.e. protected from errors of other processes. Protection of the kernel of the operating system is typically secured by internal checking mechanisms, which, particularly in connection with updates, check the authenticity of new loadable parts, since a kernel error or a spying or other malicious program endangers the security of the entire system. The division of memory management and memory access rights is also critical to the safety of the system, since it prevents the interaction between the different applications and the other parts of the system. No single application should either reserve unreasonably much memory, which would prevent the other applications from operating. In addition, for instance inter-application communication via a shared main memory, for example, is under control of the operating system of the invention.

As regards telecommunication, such as a local area network and Internet traffic, the system preferably operates in such a manner that file commands in connection with the reading of other than public files require the use of key codes. The key codes are highly encrypted packets enabling the transmission of system information between computers. The transfer of confidential files to the outside of the internal network (to the Internet) requires that the files be encrypted.

If the application uses a prohibited function (for example, other than memory access), then the system is able to perform some of the following:
Ask permission for the function, provided the user has the right to give permission. As an example may be mentioned file processing, to which the user has the right. The user/application may open the file first in read-only state, after which the user, however, wishes to change the file.
Interrupt the function by an error message to the application. An example is a write request to a file to which the application has only read access.
Interrupt the function and display an error message to the user, allowing the user to select whether the application is closed or an error status is returned to the application (a situation when the user wishes to close open files).
The application is closed and a message is transmitted to the system administrator.
The application is closed and a message is transmitted to the system administrator; in addition, the application is locked, preventing the use of any malicious program even by mistake without the acceptance of the system administrator.

In all error states, the state of the application and the function that caused the error state can be stored in a log, allowing later study of what happened or what the application in fact attempted to achieve. Temporary files can also be stored in this situation. This information may also be used to locate errors in a program.

A computer connected to the system can be monitored as remote monitoring, whereby setting and monitoring commands are transmitted in encrypted form to the computer via a local area network or an Internet connection. The computer also transmits a message about prohibited functions via the network to the administrator. This enables centralized monitoring of remote computers, for instance an employee's home computer that is connected to the employer's network. As another example may be mentioned a situation when a service provider provides program installation service and/or other support via a network and sets the parameters of the computer correctly. This way alarms regarding safety risks are obtained and the parameters of the computer are set if need be. After an alarm regarding prohibited functions, a warning message can be transmitted from the same program to all users and/or mark the application to identifiable applications that have to be eliminated from the system. As another example, IT support personnel may set computer settings and install or update applications in a centralized manner. Yet further, a subcontractor maintaining web pages may update pages on a web server remotely, but update by other outsiders is prevented.

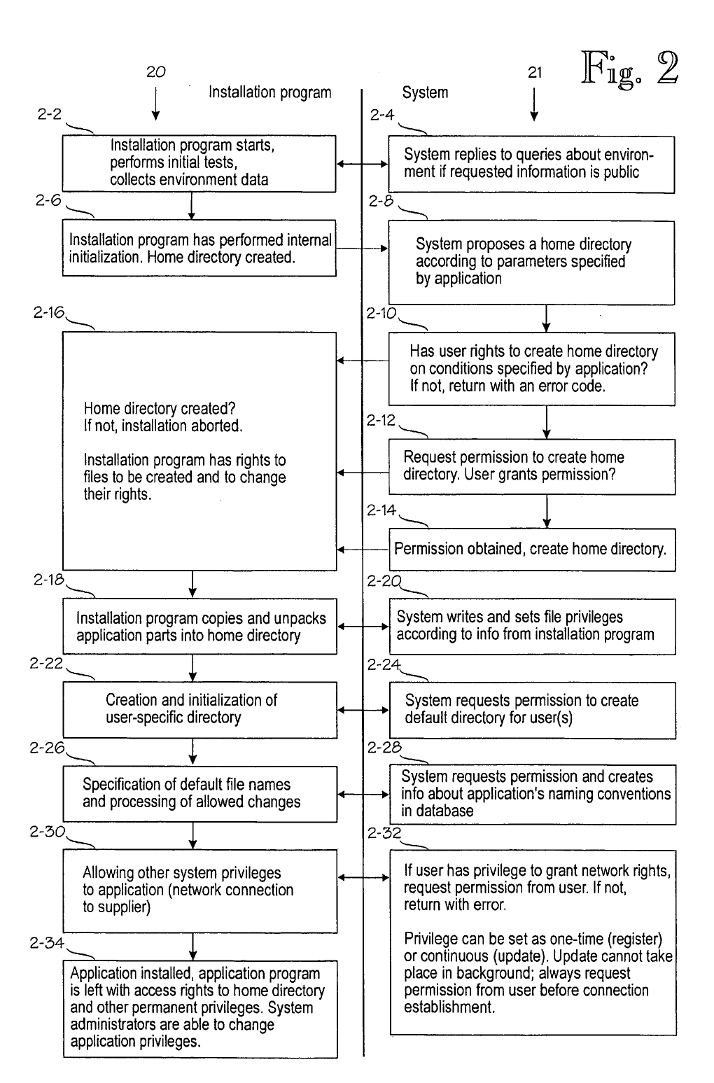

FIG. 2 shows the installation of an application program. An installation program 21, which from the point of view of the system is an example of the application 102 shown in FIG. 1, executes the phases on the left side of the vertical line, which are generally denoted by reference numeral 20. A data system provided with the function of the invention, mainly the operating system 110 of a computer and the equipment 160, executes the steps on the right side of the vertical line. These steps are commonly called installation logic and denoted by reference numeral 21.

In steps 2-2 and 2-4, the installation program is activated; it performs internal tests and collects information about its environment. The system replies to inquiries about the environment, provided the information requested is public. In step 2-6, the installation program has performed internal initialization, after which the creation of the home directory is started. In step 2-8, the system makes a proposal for the home directory according to parameters specified by the application. In step 2-10, the system checks if the user has the right to create the home directory on the conditions specified by the application? If not, return occurs by an error code. In step 2-12, the system requests permission for creating the home directory from the user and checks if the user gave the permission. In step 2-14, if the user gave the permission, the system creates the home directory.

In step 2-16, the installation program checks if the home directory is created. If not, the installation is aborted. The installation application now has access right to the files to be created and to change their rights. In step 2-18, the installation program copies and unpacks the application parts into the home directory. In step 2-20, the system writes and sets the file privileges according to the information given by the installation program.

The assumption in this example is that the installation program creates not only an application-specific home directory, but also a user-specific directory, which is created and initialized in step 2-22. In step 2-24, the system requests permission for creating a default directory for one or more users. In step 2-26, the installation program specifies the processing of the default names and allowed changes of the files. In step 2-28, the system requests permission, and having obtained the permission, creates information into the database about the name protocol of the application.

In step 2-30, the allowing of the other system rights to the application takes place, a network connection to a provider, for example. In step 2-32, if the user has the right to set network rights, permission is requested from the user. If not, return takes place by an error code. The right can be set as one-time (registration) or continuous (update). The update cannot take place in the background; instead, permission is always requested from the user before connection establishment.

In step 2-34, the application is installed and the installation program is left with access to the home directory and to other permanent rights. System administrators are able to change the privileges of an application.

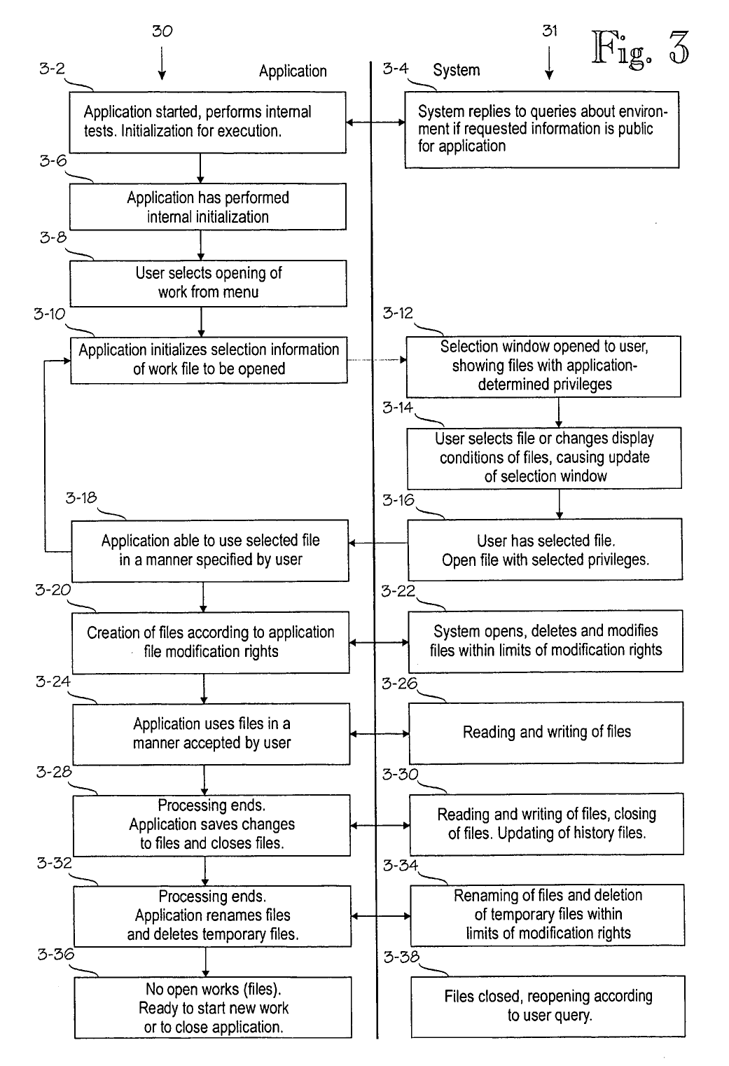

FIG. 3 shows a signalling process in connection with the execution of an application program. As FIG. 2, FIG. 3 is divided by a vertical line into steps performed by an application 30, which is an example of the application 102 of FIG. 1, and the system 110/160 of the invention. The steps performed by the system 110/160 are generally called application execution logic and designated by reference numeral 31.

In step 3-2, the application is started, and it performs internal tests and an initialization for execution. In step 3-4, the system replies to inquiries about the environment, provided the information requested is public to said application. In step 3-6, the application has performed the internal initialization. In step 3-8, the user selects the opening of a work (e.g. a file) from a menu. In step 3-10, the application initializes the selection data of the work file to be opened. In step 3-12, a selection window is opened for the user; the window showing the files the user has access rights determined by the application. In step 3-14, the user selects a file or changes the file display conditions (e.g. the directory), whereby the selection window is updated. In step 3-16, the user has selected a file, which is opened by the access rights belonging to the user and the application. In step 3-18, the application may use the selected file in the manner chosen by the user. Should the user wish to open more files, the process re-enters step 3-10.

In step 3-20, files according to the modification rights of the files of the application are created. In step 3-22, the system opens, deletes and modifies the files within the limits of the modification rights belonging to the user and the application. In step 3-24, the application uses the files to control the user. Correspondingly, in step 3-26, the system reads and writes files.

In step 3-28, the processing ends, and the application requests that the system store the changes in the files and close the files. The system implements the requested actions in step 3-30. In step 3-32, the application requests that the system rename the files and delete temporary files. In step 3-34, the system implements the requested actions. In step 3-36, the application has no open tasks (files), and it is ready to start a new task or end the application. In step 3-38, the system has closed the files; reopening takes place on the basis of a query to the user.

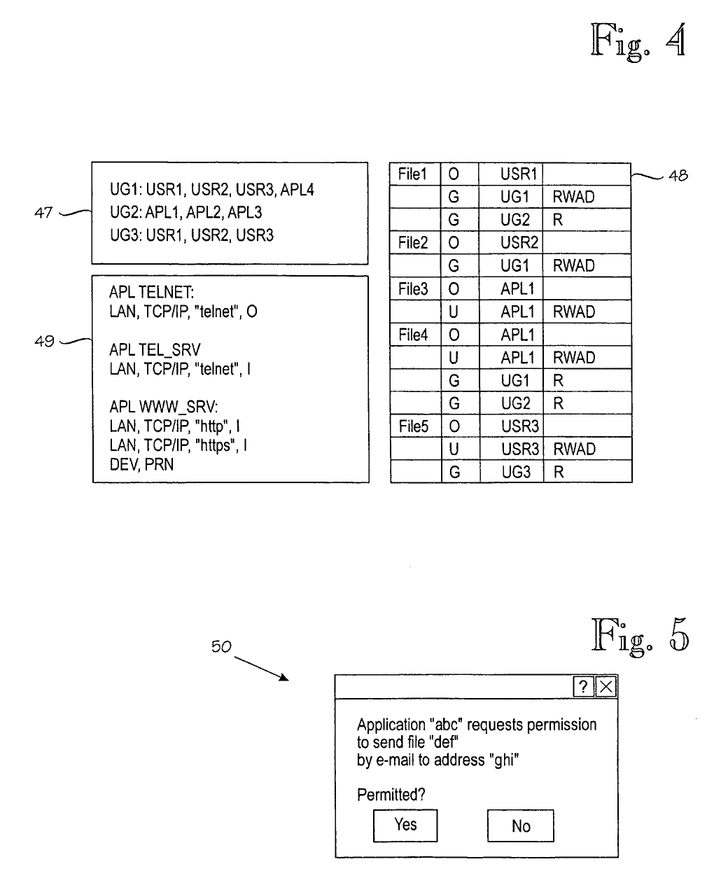

FIG. 4 shows an example of the data structures employed by an application privilege administrator. As described in connection with FIG. 1, the application privilege administrator 114 uses the privilege database 124. In addition, it may use additional data structures as shown in FIG. 4. Reference numeral 47 denotes an exemplary user group list comprising three user groups UG1 to UG3. For example, three users USR1 to USR3 and application APL4 belong to user group UG1. User group UG2 contains three applications APL 1 to APL3, etc.

Reference numeral 48 denotes an exemplary file structure, on the basis of which the rights of each user and application to each file are determined. For example, the owner (O=owner) of file File1 is user URS1, two user groups (G) have been assigned to it, the first UG1 of which is allowed to direct read, write, append and delete operations to file File1.

For example, the aforementioned project principle, wherein one project comprises a plurality of logically interconnected files, can be implemented by marking the project as the owner of a file group and by assigning the right to the files of the file group thereto.

At directory level, privileges can be specified to all directory files and default privileges to new files to be created. In addition to a user, an application can also be the owner, user or group member of a file. The file groups may be hierarchical, i.e. one tile group may comprise another file group.

Reference numeral 49 denotes an exemplary file structure indicating the access rights of different applications to the parts of the equipment. The data structure 49 is interpreted such that application TELNET is able to set up a connection with the TCP/IP protocol of a LAN device by using a telnet port. Correspondingly, application TEL_SRV may act as a receiver (server) with the TCP/IP protocol of the LAN device by using the telnet port. Application WWW_SRV may act as a receiver (server) with the TCP/IP protocol of the LAN device by using http and https ports. Furthermore, the application may use a printer (PRN).

FIG. 5 shows a dialogue window 50 when the application privilege administrator requests permission from the user of the computer to perform an operation. The assumption in this example is that application ‘abc’ requests permission to transmit file ‘def’ by email to address ‘ghi’. It is preferable for the dialogue window 50 to display the name of the application to the user and to identify the operation required by the application. If the dialogue window 50 did not show the identifier of the file and the destination address of the email, for example, a spying program could react to the user transmitting a file by email to one destination address (e.g. an offer to a client), whereby the spying program (which is located in a graphical image viewing program, for example) could request permission to transmit the same file to another address. When the dialogue window shows that an application, which usually is not assumed to transmit files by email, wishes to transmit a file to a client to an unknown destination, the user is likely to react to such a situation. Such a function may also be directly prohibited, allowing the application to be closed immediately.

1. Software for a data processing device, the software being arranged to provide, to at least one application program, system services requested thereby and selected from a predetermined group of system services, the software comprising:
a main memory allocation logic;
a mass memory allocation logic;
an application interface, via which the application program is able to request said system services from the operating system;
an application program installation and execution logic for installing said at least one application program and for specifying its identifier;
an application privilege administrator, which is:
responsive to a request directed to a system service and transmitted by said at least one application program over said application interface;
arranged to administer a group of privileges of the application program wherein the group of privileges of the application program includes a right to use a subgroup of said group of system services; and means for granting user privileges temporarily to an application program.

2. Software as claimed in claim 1, further comprising user identification logic for specifying a user identifier and a user privilege administrator for administering privileges to be assigned to one or more users on the basis of the identifier of said user.

3. Software as claimed in claim 1, wherein the application privilege administrator is arranged to apply a default-value subgroup of a system services group to an application program if a separate privilege group does not exist for said application program.

4. Software as claimed in claim 3, wherein the default-value subgroup of a system services group indicates that changes to be made to files are prohibited.

5. Software as claimed in claim 3, wherein the default-value subgroup of a system services group indicates that telecommunication functions are prohibited.

6. Software as claimed in claim 1, wherein the application privilege administrator is arranged to provide the user an option to update the application program privilege group in response to the application program requesting some predetermined system service.

7. Software as claimed in claim 6, wherein the application privilege administrator is arranged to store the updated application program privilege group for later use by the application program.

8. Software as claimed in claim 1, further comprising a logic for remote operation via a channel secured by encryption.

9. Software as claimed in claim 1, wherein the software is an operating system.

10. Software as claimed in claim 1, wherein the software is an extension to an operating system, the extension located between any application programs and security critical functions of the operating system.

11. A data processing system, comprising the software as claimed in claim 1.

12. A method of providing system services for an application program, the method comprising receiving, with a software, a request transmitted by the application program, the request being directed to a system service and, checking, in response to the request, with an application privilege administrator included in the software, if said application program, on the basis of its identifier, has access right to the requested system service, and, if so, providing the requested system service with the operating system, the method further comprising the software granting user privileges temporarily to an application program.
